(19) United States
(12) Patent Application Publication
(10) Pub. No.: US 2025/0038876 A1
(43) Pub. Date: Jan. 30, 2025

(54) SERVICE PROVIDING SERVER, SERVICE PROVIDING METHOD, AND SERVICE PROVIDING SYSTEM

(71) Applicant: SONY GROUP CORPORATION, TOKYO (JP)

(72) Inventors: KAZUMOTO KONDO, TOKYO (JP); KAZUAKI TOBA, TOKYO (JP); HIROSHI MORITA, TOKYO (JP); MASANARI YAMAMOTO, TOKYO (JP); CHUAN YU, TOKYO (JP)

(21) Appl. No.: 18/713,742

(22) PCT Filed: Oct. 13, 2022
(86) PCT No.: PCT/JP2022/038137

§ 371 Date: May 28, 2024

(30) Foreign Application Priority Data
Dec. 3, 2021 (JP) 2021-196675

(51) Int. Cl. H04J 14/02; H04L 43/0852

(52) U.S. Cl. CPC H04J 14/0227; H04L 43/0852

(57) ABSTRACT

[Object] To equalize delay times when providing a common service to a plurality of terminal apparatuses. [Solving Means] A service providing server includes: an all-photonics network communication interface for connecting to an all-photonics network; a photonic path management unit that requests a network management server to generate and connect respective photonic paths to a plurality of terminal apparatuses connectable to the all-photonics network; a photonic path determining unit that determines to use the respective photonic paths with respect to which a delay time difference becomes equal to or smaller than a target value, the delay time difference being a difference between delay times of the respective photonic paths generated by the network management server; and a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server.

### TECHNICAL FIELD

The present disclosure relates to a service providing server, a service providing method, and a service providing system that provide a plurality of terminal apparatuses with a common service that users experience together.

### BACKGROUND ART

A first-person shooter (FPS), a kind of shooting game, where the player can freely move in game world and space in the player's viewpoint (first-person) of an operated character and fight with weapons, his or her bare hands, or the like is known. In the current Internet network, a delay time difference between players may increase. Therefore, the players may not be able to play fairly under the same conditions. For example, in a shooting game using a first-person perspective like an FPS, one player's motion can be slower than his or her opponent's motion, for example, which is disadvantageous for the one player.

However, due to the best-effort delivery, the current Internet communication scheme cannot ensure communication line quality such as communication band and delay. Moreover, since the players cannot acquire even information about a network equipment configuration, it is impossible to estimate a delay time simply on the basis of a distance. On the other hand, a network company can acquire information about a network configuration to some extent, but it is not a fixed time because the delay time dynamically varies depending on traffic.

Therefore, countermeasures such as increasing the frame rate of a display or using a higher speed Internet network for reducing the delay time difference and increasing the speed have been employed.

### CITATION LIST

### Patent Literature

Patent Literature 1: Japanese Patent Application Laid-open No. 2017-98862

### DISCLOSURE OF INVENTION

### Technical Problem

In communication via the existing Internet network, it is difficult to equalize delay times of a plurality of players. Therefore, currently, a plurality of players assembles in the same site for an E-sports championship and the E-sports championship takes place via an Ethernet hub. Conversely, it is difficult to eliminate influences of the Internet network for realizing a remote E-sports championship with fair delays from remote locations.

In Patent Literature 1, a virtual machine is arranged in a physical game server arranged at the center between hubs, thereby adjusting a delay time difference between each hub and the game server. However, in particular, in a case of transmitting a massive amount of AV data, CPU processing and memory resources are consumed for a buffer, and thus the resources may be wasted with saved electric power and load may be added to a terminal apparatus of a player who is a client.

In view of the above-mentioned circumstances, it is an objective of the present disclosure to equalize delay times when providing a common service to a plurality of terminal apparatuses.

### Solution to Problem

A service providing server according to an embodiment of the present disclosure including:
an all-photonics network communication interface for connecting to an all-photonics network;
a photonic path management unit that requests a network management server to generate and connect respective photonic paths to a plurality of terminal apparatuses connectable to the all-photonics network;
a photonic path determining unit that determines to use the respective photonic paths with respect to which a delay time difference becomes equal to or smaller than a target value, the delay time difference being a difference between delay times of the respective photonic paths generated by the network management server; and
a service providing unit that provides a common service that is commonly experienced by users of the plurality of terminal apparatuses to the plurality of terminal apparatuses via the respective photonic paths with respect to which the delay time difference becomes equal to or smaller than the target value, the respective photonic paths being connected by the network management server.

Accordingly, the delay time difference between the terminal apparatuses can be made to be equal to or smaller than the target value, i.e., the delay times can be equalized.

In a case where the photonic path determining unit determines that the delay time difference between the respective photonic paths is larger than the target value, the photonic path management unit may request the network management server to regenerate one photonic path so that the delay time difference becomes equal to or smaller than the target value.

Even in a case where the delay time difference is larger than the target value, by regenerating the photonic path, the delay time difference between the terminal apparatuses can be made to be equal to or smaller than the target value, i.e., the delay times can be equalized.

The photonic path management unit may request the network management server to regenerate photonic paths other than a photonic path which has a maximum delay time so that a delay time difference with respect to the maximum delay time becomes equal to or smaller than the target value.

By regenerating the photonic path to the terminal apparatus to be extended so that the delay times to the terminal apparatuses which do not have the maximum delay time is adjusted to the delay time to the terminal apparatus, which is the maximum delay time, the delay time difference between the terminal apparatuses can be made to be equal to or smaller than the target value, i.e., the delay times can be equalized.

The photonic path management unit may
request the network management server to generate a plurality of photonic paths to one terminal apparatus, and
request, in a case where the photonic path determining unit determines that a delay time difference between each of the plurality of photonic paths to the one terminal apparatus and a photonic path to another terminal apparatus is larger than the target value, the network management server to regenerate photonic paths other than a photonic path which has a maximum delay time so that a delay time difference with respect to the maximum delay time becomes equal to or smaller than the target value.

By generating the plurality of photonic paths, the delay time difference between the terminal apparatuses can be more reliably made to be equal to or smaller than the target value, i.e., the delay times can be equalized.

The service providing server may further include a delay management unit that causes, in a case where the photonic path determining unit determines that the delay time difference between the respective photonic paths is larger than the target value after regeneration of the respective photonic paths, the service providing unit or a terminal apparatus connected through at least photonic paths other than a photonic path which has a maximum delay time to delay sending and/or executing a command so that the delay time difference becomes equal to or smaller than the target value.

Even in a case where the delay time difference is larger than the target value, by delaying sending and/or executing the command, the delay time difference between the terminal apparatuses can be made to be equal to or smaller than the target value, i.e., the delay times can be equalized.

The photonic path management unit may notify the plurality of terminal apparatuses
of the delay times of the respective photonic paths, and/or
that the delay time difference becomes equal to or smaller than the target value.

Accordingly, users of the terminal apparatuses can know that they will fight under fair conditions.

The photonic path determining unit may determine to use a photonic path with low power consumption.

The photonic path determining unit may determine to use a set of photonic paths with lower total power consumption in a case where the photonic path determining unit determines that there is a plurality of sets of the respective photonic paths with respect to which the delay time difference becomes equal to or smaller than the target value.

The power consumption of the photonic path may be calculated on the basis of power consumption of each of a plurality of ports included in the photonic path.

The photonic paths with respect to which the delay time difference becomes equal to or smaller than the target value may be generated by moving an instance of the service providing server.

Accordingly, the delay times of the photonic paths to the terminal apparatuses can be made closer values. Therefore, the delay time difference can be reduced.

The delay time of the photonic path may be calculated on the basis of a communication time depending on a distance of the photonic path and latency of each of a plurality of ports included in the photonic path.

In view of this, in the present embodiment, focusing on characteristics that “the delay time associated with the communication between the hubs is the fixed value” in the all-photonics network, a delay time difference between the delay time from the service providing server to the terminal apparatus and the delay time from the service providing server to the terminal apparatus can be made to be equal to or smaller than a target value, i.e., the delay times are equalized.

A service providing method according to an embodiment of the present disclosure includes:
requesting a network management server to generate and connect respective photonic paths to a plurality of terminal apparatuses connectable to an all-photonics network;
determining to use the respective photonic paths with respect to which a delay time difference becomes equal to or smaller than a target value, the delay time difference being a difference between delay times of the respective photonic paths generated by the network management server; and
providing a common service that is commonly experienced by users of the plurality of terminal apparatuses to the plurality of terminal apparatuses via the respective photonic paths with respect to which the delay time difference becomes equal to or smaller than the target value, the respective photonic paths being connected by the network management server.

A service providing system according to an embodiment of the present disclosure includes:
a service providing server including
an all-photonics network communication interface for connecting to an all-photonics network,
a photonic path management unit that requests a network management server to generate and connect respective photonic paths to a plurality of terminal apparatuses connectable to the all-photonics network,
a photonic path determining unit that determines to use the respective photonic paths with respect to which a delay time difference becomes equal to or smaller than a target value, the delay time difference being a difference between delay times of the respective photonic paths generated by the network management server, and
a service providing unit that provides a common service that is commonly experienced by users of the plurality of terminal apparatuses to the plurality of terminal apparatuses via the respective photonic paths with respect to which the delay time difference becomes equal to or smaller than the target value, the respective photonic paths being connected by the network management server; and
the network management server that generates and connects the respective photonic paths to the plurality of terminal apparatuses from the service providing server.

The service providing system may further include
the terminal apparatus including an all-photonics network communication interface for connecting to the all-photonics network.

### BRIEF DESCRIPTION OF DRAWINGS

FIG. 1 shows a configuration of a service providing system according to a first embodiment of the present disclosure.

FIG. 2 shows a concept of the service providing system.

FIG. 3 shows another method for accomplishing the concept of the service providing system.

FIG. 4 shows a functional configuration of the service providing system.

FIG. 5 shows a resource management database.

FIG. 6 shows an operation sequence of the service providing system.

FIG. 7 shows an operation flow of a service providing server.

FIG. 8 shows an operation flow of a photonic path determining unit.

FIG. 9 is a diagram for describing an operation of a delay management unit.

FIG. 10 shows an operation sequence of a service providing system according to a second embodiment.

FIG. 11 shows an operation flow of the service providing server.

### MODE(S) FOR CARRYING OUT THE INVENTION

Hereinafter, embodiments of the present disclosure will be described with reference to the drawings.

### I. First Embodiment

### 1. Overview of Service Providing System

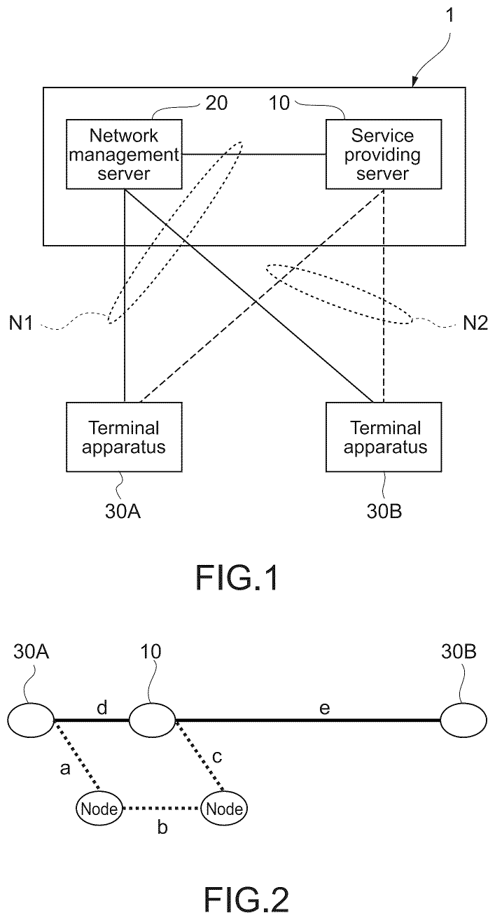

FIG. 1 shows a configuration of a service providing system according to a first embodiment of the present disclosure.

A service providing system 1 includes a service providing server 10 and a network management server 20. The service providing server 10 is connected to an Internet N1 and an all-photonics network N2. The network management server 20 is connected to at least the Internet N1. The service providing server 10 and the network management server 20 communicate with each other typically via the Internet N1. However, the service providing server 10 and the network management server 20 may communicate with each other via the all-photonics network N2. The Internet N1 and the all-photonics network N2 each include a plurality of nodes (not shown).

It should be noted that in the present embodiment, the all-photonics network N2 also includes a case where it performs all-photonics communication to a router at an end point and it is connected to terminal apparatuses 30 by photoelectric conversion. In other words, the all-photonics network N2 includes both a case of performing photoelectric conversion inside the terminal apparatus 30 and a case of performing photoelectric conversion outside the terminal apparatus 30. It should be noted that a delay difference between the case of performing photoelectric conversion inside the terminal apparatus 30 and the case of performing photoelectric conversion outside the terminal apparatus 30 becomes a significantly small value which is not msec order, so it is an actually ignorable time, and it does not affect realization of the present embodiment.

The service providing system 1 may further include one or more terminal apparatuses 30. The plurality of terminal apparatuses 30 is connected to the Internet N1 and the all-photonics network N2. The terminal apparatuses 30 is typically a personal computer and is used by an end user. The plurality of terminal apparatuses 30 is typically installed at remote sites, not at the same site. Hereinafter, when the plurality of terminal apparatuses 30 is distinguished from each other, they will be sometimes referred to as terminal apparatuses 30A and 30B.

The service providing server 10 establishes connection of the plurality of terminal apparatuses 30 installed at remote sites via the Internet N1. Then, the service providing server 10 provides a common service that users experience together to the plurality of terminal apparatuses 30 via photonic paths of the all-photonics network N2, which are photonic paths generated and connected by the network management server 20. The “common service that users experience together” is typically a fight-type computer game (i.e., E-sports) such as an FPS or a computer game in which three or more players participate simultaneously. In these cases, the service providing server 10 is a so-called game server. However, not limited thereto, the “common service that users experience together” may be an on-line meeting or a service including an element for simultaneously viewing common AV content. In a case where the service is an FPS, the service providing server 10 provides a service to two terminal apparatuses 30. However, three or more terminal apparatuses 30 may be provided.

The network management server 20 manages the photonic paths of the all-photonics network N2. Specifically, the network management server 20 receives a request from the service providing server 10 and generates and connects a photonic path via the all-photonics network N2 to the terminal apparatus 30A from the service providing server 10 and a photonic path via the all-photonics network N2 to the terminal apparatus 30B from the service providing server 10.

The all-photonics network N2 communicates any types of data as optical signals in the communication channel (photonic path) including the plurality of nodes to the terminal apparatuses 30 from the service providing server 10 without performing any photoelectric conversion. In general, the all-photonics network is a technology of processing all network transfer functions including a multiplexing/demultiplexing function, a switching function, and a routing function in the photonic domain and performing data communication without control in the electrical domain. Since the all-photonics network does not perform photoelectric conversion, a router does not check electrical signals and perform routing unlike the Internet. In the all-photonics network, a communication channel (photonic path) between hubs is determined in advance and communication between the hubs occupies a single communication channel, such that the communication between the hubs is ensured irrespective of information included in electrical signals. Thus, due to the characteristics that the communication occupies the communication channel, other communication traffic does not influence the communication in the all-photonics network. Therefore, in the all-photonics network, a delay time associated with the communication between the hubs is a fixed value unlike the Internet where the delay time dynamically varies due to traffic influences of communication between the other hubs.

FIG. 2 shows a concept of the service providing system.

In view of this, in the present embodiment, focusing on characteristics that “the delay time associated with the communication between the hubs is the fixed value” in the all-photonics network, a delay time difference between a delay time to the terminal apparatus 30A from the service providing server 10 and a delay time to the terminal apparatus 30B from the service providing server 10 is equal to or smaller than a target value, i.e., the delay times are equalized.

For example, a minimum delay time to the terminal apparatus 30A from the service providing server 10 is a value obtained by adding up a communication time depending on a distance d of the shortest photonic path and total latency of a plurality of ports included in the photonic path. On the other hand, the minimum delay time to the terminal apparatus 30B from the service providing server 10 is a value obtained by adding up a communication time depending on a distance e of the shortest photonic path and total latency of a plurality of ports included in the photonic path. Here, it is assumed that the minimum delay time to the terminal apparatus 30B>the minimum delay time to the terminal apparatus 30A and the delay time difference is larger than the target value.

At this time, a photonic path to the terminal apparatus 30A is regenerated to be extended so that the delay time to the terminal apparatus 30A (the delay time is shorter) which is not the maximum delay time is adjusted to the delay time to the terminal apparatus 30B (the delay time is longer) which is the maximum delay time. For example, a photonic path a+b+c to the terminal apparatus 30A from the service providing server 10 is regenerated. Accordingly, the delay time difference between the terminal apparatuses 30A and 30B can be made to be equal to or smaller than the target value, i.e., the delay times can be equalized.

Accordingly, the users of the plurality of terminal apparatuses 30A and 30B together experience the common service fairly from remote locations (e.g., they perform a fight-type game under fair conditions).

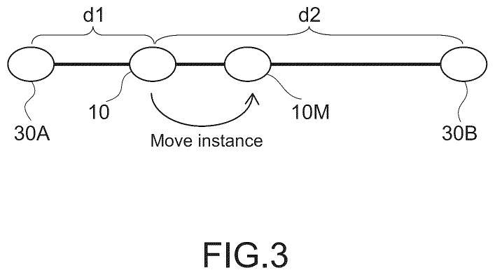

FIG. 3 shows another method for accomplishing the concept of the service providing system.

By moving an instance of the service providing server 10, photonic paths with respect to which the delay time difference becomes equal to or smaller than the target value may be generated.

For example, the delay time to the terminal apparatus 30A from the service providing server 10 is a value obtained by adding up the communication time depending on the distance d1 of the photonic path and the total latency of the plurality of ports included in the photonic path. On the other hand, the delay time to the terminal apparatus 30B from the service providing server 10 is a value obtained by adding up communication time depending on a distance d2 of the photonic path and the total latency of the plurality of ports included in the photonic path. Here, the delay time to the terminal apparatus 30B>the delay time to the terminal apparatus 30A and the delay time difference is larger than the target value.

At this time, the instance of the service providing server 10 is moved to a service providing server 10M so as to approach the terminal apparatus 30B which has the maximum delay time and photonic paths to the terminal apparatuses 30A and 30B are regenerated so that the delay times to the terminal apparatuses 30A and 30B are equalized. Accordingly, the delay time difference between the terminal apparatuses 30A and 30B can be made to be equal to or smaller than the target value, i.e., the delay times can be equalized.

### 2. Functional Configuration of Service Providing System

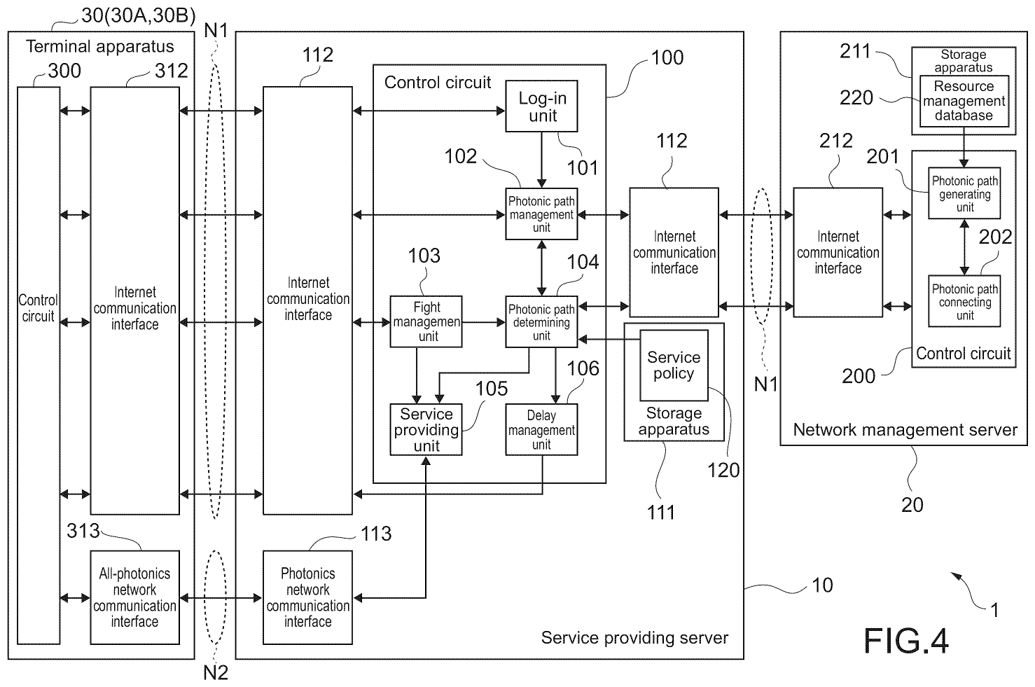

FIG. 4 shows a functional configuration of the service providing system.

The service providing server 10 includes a control circuit 100, a large-volume nonvolatile storage apparatus 111, such as an HDD or an SSD, an Internet communication interface 112, and an all-photonics network communication interface 113. The all-photonics network communication interface 113 is connected to be capable of communicating with the plurality of terminal apparatuses 30 via the all-photonics network N2. In the control circuit 100 of the service providing server 10, the CPU operates as a log-in unit 101, a photonic path management unit 102, a fight management unit 103, a photonic path determining unit 104, a service providing unit 105, and a delay management unit 106 by loading the information processing program stored in the ROM into the RAM and executing it. The storage apparatus 111 stores a service policy 120.

The service policy 120 is an all-photonics network connection policy when the service providing server 10 provides a service. The service policy 120 may be provided for each service (e.g., for each game title) or may be provided for each time of providing the service (e.g., for each play, for each E-sports championship). The service policy 120 at least includes a target value of the delay time difference. The service policy 120 may further include an adjustment method (photonic path adjustment and buffer adjustment) used for accomplishing the target value of the delay time difference or a target value of power consumption.

The “delay time difference” is a difference between delay times of respective photonic paths to the plurality of terminal apparatuses 30 from the service providing server 10. Specifically, in a case where two terminal apparatuses 30 are provided, the “delay time difference” is a difference between the delay time of the photonic path to the terminal apparatus 30A from the service providing server 10 and the delay time of the photonic path to the terminal apparatus 30B from the service providing server 10. In a case where two terminal apparatuses 30 are provided, the “delay time difference” is a maximum difference among the delay times of the respective photonic paths to the plurality of terminal apparatuses 30 from the service providing server 10.

For example, provided that a target delay difference is one frame, the target value of the delay time difference is 16.7 msec (=1 sec/60 frame) at a frame rate of 60 fps (frame per second).

The terminal apparatuses 30 includes a control circuit 300, a large-volume nonvolatile storage apparatus (not shown) such as an HDD or an SSD, an Internet communication interface 312, and an all-photonics network communication interface 313. The terminal apparatuses 30 is typically a personal computer and further includes physical user interfaces (not shown) such as output apparatuses such as display and loudspeaker and input apparatuses such as keyboards, mouses, and microphones.

The network management server 20 includes a control circuit 200, a high-volume nonvolatile storage apparatus 211 such as an HDD and an SSD, and an Internet communication interface 212. The network management server 20 may include an all-photonics network communication interface. In the control circuit 200 of the network management server 20, the CPU operates as a photonic path generating unit 201 and a photonic path connecting unit 202 by loading the information processing program stored in the ROM into the RAM and executing it. The storage apparatus 211 stores a resource management database 220.

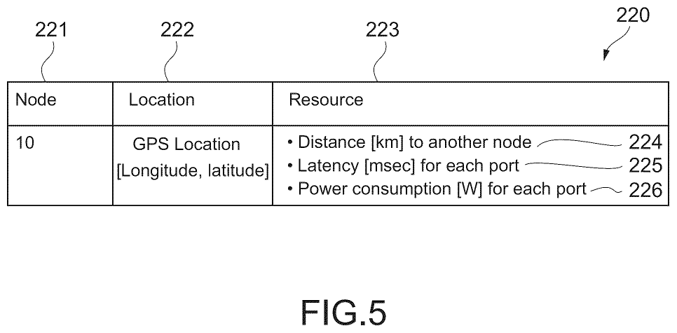

FIG. 5 shows a resource management database.

The resource management database 220 stores information of a plurality of nodes included in the all-photonics network N2 managed by the network management server 20. Specifically, the resource management database 220 stores, for each node, a node identifier 221, a location 222, and resource information 223 in association with each other.

The node identifier 221 uniquely identifies each node. The location 222 is GPS location information of each node and is expressed by longitude and latitude. The resource information 223 includes a distance 224, latency 225 for each port, and power consumption 226 for each port.

The distance 224 is a distance (km) from a node identified by the node identifier 221 to each node directly connected thereto (i.e., adjacent thereto). In a case where the node is a node in the lowest layer (multi-granularity centralized unit or sub-wavelength centralized unit), the distance 224 may include a distance from the node to the terminal apparatus 30. The latency 225 for each port is latency (msec) for each optical switch port included in the node identified by the node identifier 221. The power consumption 226 for each port is power consumption (W) for each port included in the node identified by the node identifier 221.

### 3. Operation of Service Providing System

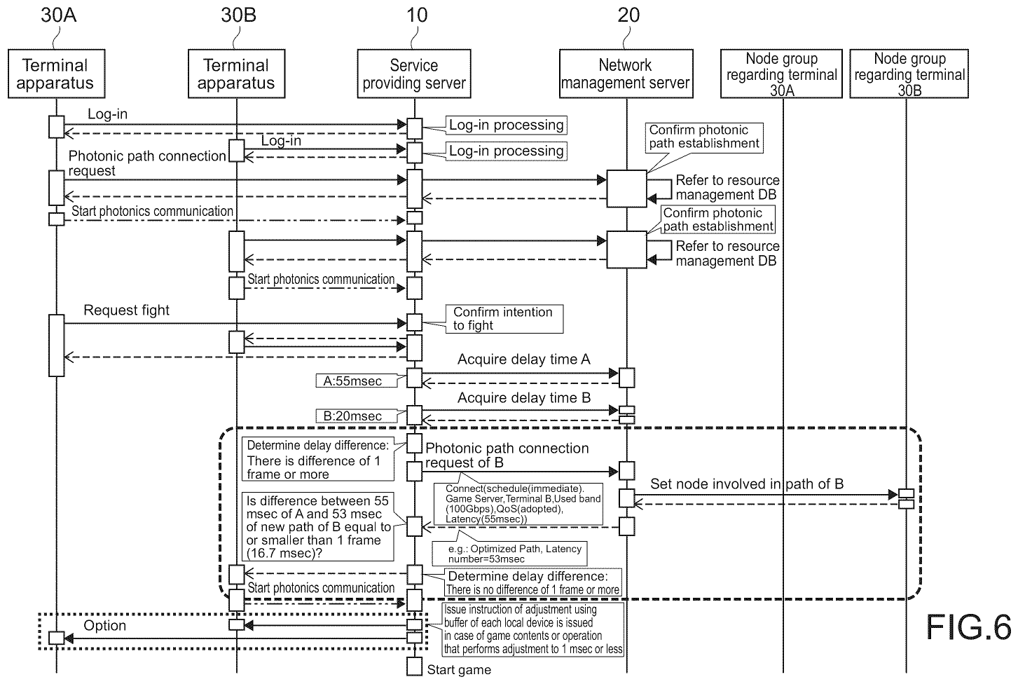

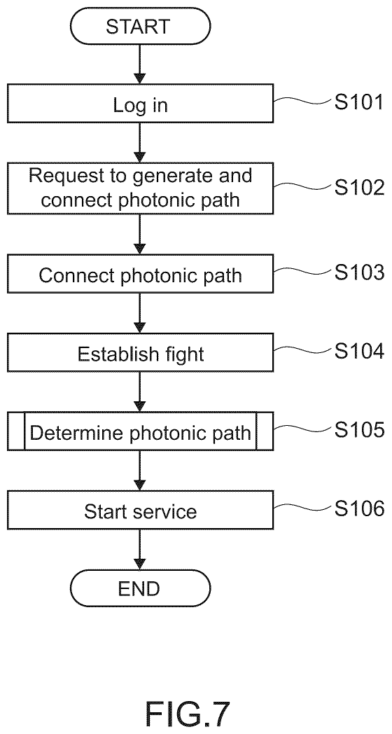

FIG. 6 shows an operation sequence of the service providing system. FIG. 7 shows an operation flow of the service providing server.

In the following description, the service providing server 10 is a game server and provides a one-on-one fight-type computer game. The terminal apparatuses 30A and 30B are respectively used by fighters (two people) of this computer game.

The log-in unit 101 of the service providing server 10 receives, from the terminal apparatuses 30A and 30B via the Internet N1, a log-in request including account information (ID, password) of the user who uses the terminal apparatuses 30A and 30B. In a case where authentication of the received account information (ID, password) is successful, the log-in unit 101 receives log-in of the user and establishes connection between the service providing server 10 and the terminal apparatuses 30A and 30B. The log-in unit 101 sends a notification of the successful log-in to the terminal apparatuses 30A and 30B via the Internet N1 (Step S101).

When the terminal apparatuses 30A and 30B receive the notification of the successful log-in, the terminal apparatuses 30A and 30B sends photonic path connection requests with the service providing server 10 to the service providing server 10 via the Internet N1. The photonic path connection request includes a schedule (in this example, immediate), a connection hub (terminal apparatus 30A or 30B, service providing server 10), a used band (e.g., 100 Gbps), QoS (in this example, adopted), and a target delay time (0 msec. It means the shortest time, i.e., the shortest distance).

When the photonic path management unit 102 of the service providing server 10 receives the photonic path connection requests from the terminal apparatuses 30A and 30B via the Internet N1, the photonic path management unit 102 sends to the network management server 20 a photonic path generation and connection request for requesting to generate and connect the respective photonic paths to the terminal apparatuses 30A and 30B from the service providing server 10 in accordance with the photonic path connection request (Step S102). The photonic path generation and connection request includes a schedule (in this example, immediate), a connection hub (terminal apparatus 30A or 30B, service providing server 10), a used band (e.g., 100 Gbps), and QoS (in this example, adopted).

The photonic path generating unit 201 of the network management server 20 receives the photonic path generation and connection request from the service providing server 10. The photonic path generating unit 201 refers to the resource management database 220 and generates a photonic path to the terminal apparatus 30A from the service providing server 10 and a photonic path to the terminal apparatus 30B from the service providing server 10. For example, the service providing server 10 refers to the distance 224 of the resource management database 220 and respectively generates shortest-distance photonic paths to the terminal apparatuses 30A and 30B from the service providing server 10.

The photonic path connecting unit 202 of the network management server 20 establishes connection of the shortest-distance photonic paths to the terminal apparatuses 30A and 30B from the service providing server 10, which have been generated by the photonic path generating unit 201. The photonic path generating unit 201 sends to the service providing server 10 information for performing communication through the respective photonic paths to the terminal apparatuses 30A and 30B from the service providing server 10.

The photonic path management unit 102 of the service providing server 10 receives from the network management server 20 the information for performing communication through the respective photonic paths to the terminal apparatuses 30A and 30B from the service providing server 10. The photonic path management unit 102 sends the information for performing communication through the respective photonic paths to the terminal apparatuses 30A and 30B from the service providing server 10 to the terminal apparatuses 30A and 30B via the Internet N1. Accordingly, the photonic path is connected between the service providing server 10 and each of the terminal apparatuses 30A and 30B and communication via the all-photonics network N2 can be started (Step S103).

The fight management unit 103 of the service providing server 10 receives, from the terminal apparatus 30A via the Internet N1 or the all-photonics network N2, a fight request that specifies a particular user (in this example, the user of the terminal apparatus 30B) as a fight opponent. The fight management unit 103 sends an inquiry for confirming an intention to fight to the terminal apparatus 30B in which the user specified by the fight request logs via the Internet N1 or the all-photonics network N2. The fight management unit 103 receives a reply indicating that the user intends to fight from the terminal apparatus 30B via the Internet N1 or the all-photonics network N2. The fight management unit 103 notifies, via the Internet N1 or the all-photonics network N2, the terminal apparatus 30A that a fight between the terminal apparatuses 30A and 30B is established (Step S104).

The photonic path determining unit 104 of the service providing server 10 determines the respective photonic paths to the terminal apparatuses 30A and 30B from the service providing server 10 (Step S105). Hereinafter, an operation of the photonic path determining unit 104 will be described. The operation of the photonic path determining unit 104 corresponds to a portion surrounded by the frame in the sequence diagram of FIG. 6. Moreover, hereinafter, the terminal apparatuses 30A and 30B will be sometimes simply referred to as “A, B” in the figures.

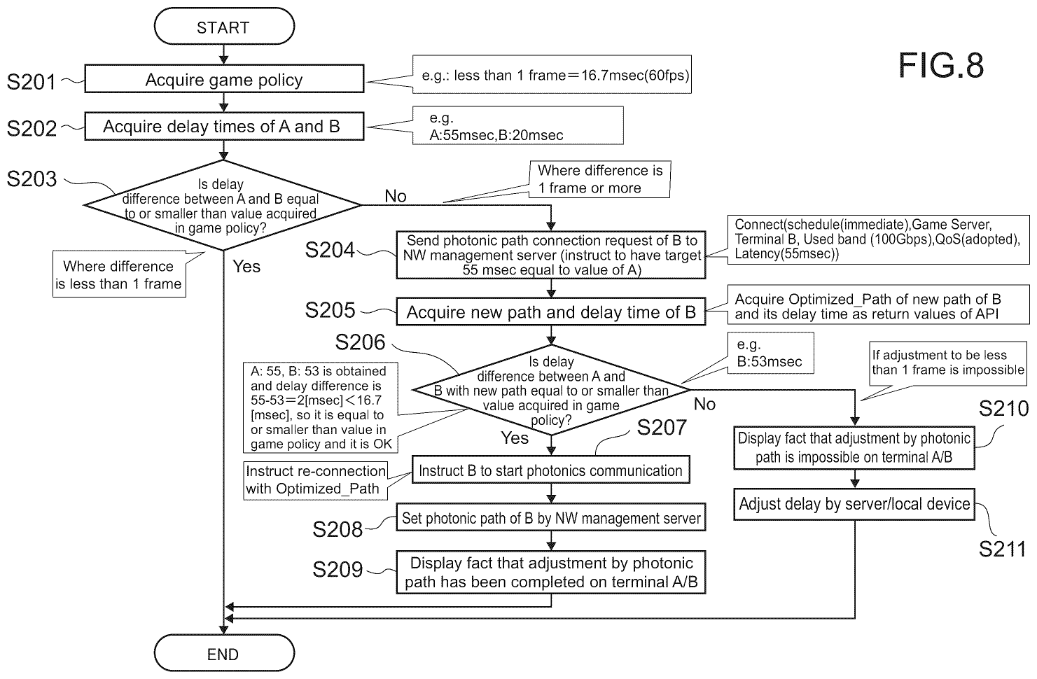

FIG. 8 shows an operation flow of the photonic path determining unit.

The photonic path determining unit 104 of the service providing server 10 refers to the service policy 120 and reads out a target value of the delay time difference, an adjustment method (photonic path adjustment and buffer adjustment) used for accomplishing the target value of the delay time difference, and a target value of power consumption for example (Step S201). In this example, the target value of the delay time difference is set to 16.7 msec (equivalent to one frame at 60 fps).

The photonic path determining unit 104 of the service providing server 10 inquires (Step S202) of the network management server 20 about delay times of the respective photonic paths to the terminal apparatuses 30A and 30B to which the network management server 20 has been connected (Step S103).

The photonic path generating unit 201 of the network management server 20 receives the inquiry from the service providing server 10. Then, the photonic path generating unit 201 refers to the resource management database 220 and calculates delay times of the respective photonic paths to the terminal apparatuses 30A and 30B from the service providing server 10. Specifically, the photonic path generating unit 201 calculates the delay times of the photonic paths on the basis of the communication time depending on the distance of the photonic path (total distance 224) and the latency (total latency 225) of the plurality of ports included in the photonic path (by adding up the communication time and the total latency). The photonic path generating unit 201 sends the delay times of the respective photonic paths to the terminal apparatuses 30A and 30B to the service providing server 10 from the service providing server 10.

The photonic path determining unit 104 of the service providing server 10 receives from the network management server 20 the delay times of the respective photonic paths to the terminal apparatuses 30A and 30B. In this example, the delay time of the photonic path to the terminal apparatus 30A from the service providing server 10 is 55 msec and the delay time of the photonic path to the terminal apparatus 30B from the service providing server 10 is 20 msec.

The photonic path determining unit 104 determines (Step S203) whether or not a delay time difference which is a difference between the delay time (55 msec) of the photonic path to the terminal apparatus 30A from the service providing server 10 and the delay time (20 msec) of the photonic path to the terminal apparatus 30B from the service providing server 10 is equal to or smaller than the target value (16.7 msec) of the delay time difference in the service policy 120 (Step S201).

The photonic path determining unit 104 determines that the delay time difference is equal to or smaller than the target value (16.7 msec) and the target value is accomplished (Step S203, YES). In this case, the service providing unit 105 uses the photonic paths connected (Step S103) with respect to which the delay time difference becomes equal to or smaller than the target value to perform communication with each of the terminal apparatuses 30A and 30B via the all-photonics network N2 and start to provide the service (game) (Step S106).

On the other hand, in this example, the photonic path determining unit 104 determines that the delay time difference (55−20=35 msec, equivalent to about two frames) is larger than the target value (16.7 msec, equivalent to one frame) and the target value is not accomplished (Step S203, NO).

The photonic path determining unit 104 compares the delay time (55 msec) of the photonic path to the terminal apparatus 30A with the delay time (20 msec) of the photonic path to the terminal apparatus 30B and determines a photonic path which has a maximum delay time and another photonic path. In this example, the photonic path determining unit 104 determines that the photonic path to the terminal apparatus 30A has a maximum delay time (55 msec) and the photonic path to the terminal apparatus 30B has a delay time (20 msec) other than the maximum delay time.

The photonic path management unit 102 of the service providing server 10 sends to the network management server 20 a photonic path regeneration request for requesting to regenerate a photonic path which does not have the maximum delay time, i.e., the photonic path to the terminal apparatus 30B. The photonic path regeneration request includes a schedule (in this example, immediate), a connection hub (terminal apparatus 30B, service providing server 10), a used band (e.g., 100 Gbps), QoS (in this example, adopted), and a target delay time (55 msec). The “target delay time” is the maximum delay time, i.e., the delay time (55 msec) of the photonic path to the terminal apparatus 30A. In other words, the photonic path management unit 102 requests the network management server 20 to regenerate a photonic path to the terminal apparatus 30B, which is a photonic path other than the photonic path to the terminal apparatus 30A with the maximum delay time (55 msec), so that the delay time difference from the maximum delay time (55 msec) becomes equal to or smaller than the target value (16.7 msec) (Step S204).

The photonic path generating unit 201 of the network management server 20 receives the photonic path regeneration request from the service providing server 10. The photonic path generating unit 201 refers to the resource management database 220 and regenerates a photonic path to the terminal apparatus 30B from the service providing server 10. For example, the photonic path generating unit 201 refers to the distance 224 and the latency 225 of the resource management database 220 and regenerates a photonic path (so-called detouring photonic path) with respect to which the delay time to the terminal apparatus 30B from the service providing server 10 is the closest to 55 msec, as Optimized_Path. The photonic path generating unit 201 sends to the service providing server 10 information for performing communication in the regenerated photonic path (Optimized_Path) to the terminal apparatus 30B and a delay time of this photonic path.

The photonic path management unit 102 of the service providing server 10 receives from the network management server 20 the information for performing communication in the regenerated photonic path (Optimized_Path) to the terminal apparatus 30B and the delay time of this photonic path (Step S205). In this example, the delay time of the regenerated photonic path (Optimized_Path) is 53 msec.

The photonic path determining unit 104 of the service providing server 10 determines (Step S206) whether or not a delay time difference, which is a difference between the delay time (55 msec) of the photonic path to the terminal apparatus 30A and the delay time (53 msec) of the regenerated photonic path (Optimized_Path) to the terminal apparatus 30B, is equal to or smaller than a target value (16.7 msec) of the delay time difference in the service policy 120 (Step S201). In this example, the photonic path determining unit 104 determines that the delay time difference (55−53=2 msec) is equal to or smaller than the target value (16.7 msec) and the target value has been accomplished (Step S206, YES). Thus, the photonic path determining unit 104 determines to use the respective photonic paths (delay times 55 msec and 53 msec) with respect to which the delay time difference (2 msec) becomes equal to or smaller than the target value (16.7 msec).

The photonic path management unit 102 of the service providing server 10 sends information for performing communication in the regenerated photonic path (Optimized_Path) to the terminal apparatus 30B and a delay time (53 msec) of this photonic path to the terminal apparatus 30B via the Internet N1 or the all-photonics network N2. Accordingly, the communication via the photonic paths (Optimized_Path) of the all-photonics network N2 can be started between the service providing server 10 and the terminal apparatus 30B (Step S207).

The photonic path management unit 102 of the service providing server 10 sends to the network management server 20 a photonic path connection establishment request for the network management server 20 to connect the regenerated photonic path (Optimized_Path) to the terminal apparatus 30B from the service providing server 10. The photonic path connection establishment request includes a schedule (in this example, immediate), a connection hub (terminal apparatus 30B, service providing server 10), a used band (e.g., 100 Gbps), QoS (in this example, adopted), and Optimized_Path (i.e., a parameter for determining the photonic path) (Step S208).

The photonic path connecting unit 202 of the network management server 20 receives the photonic path connection establishment request from the service providing server 10. The photonic path connecting unit 202 establishes connection of the photonic path (Optimized_Path) to the terminal apparatus 30B determined by the photonic path connection establishment request. The photonic path connecting unit 202 sends to the service providing server 10 a notification indicating that the connection of the photonic path (Optimized_Path) to the terminal apparatus 30B has been established.

When the photonic path management unit 102 of the service providing server 10 receives the notification from the network management server 20, the photonic path management unit 102 of the service providing server 10 notifies the terminal apparatuses 30A and 30B of respective delay times (55 msec, 53 msec) via the Internet N1 or the all-photonics network N2. Additionally/alternatively, the photonic path management unit 102 may notify the terminal apparatuses 30A and 30B that communication is enabled using the photonic path with respect to which the delay time difference (2 msec) becomes equal to or smaller than the target value (16.7 msec) (Step S209). Accordingly, the fighters can know that they will fight under fair conditions.

The service providing unit 105 of the service providing server 10 uses the photonic paths with respect to which the delay time difference becomes equal to or smaller than the target value to perform communication with each of the terminal apparatuses 30A and 30B via the all-photonics network N2 and start to provide the service (game) (Step S106). As a result, the terminal apparatus 30B is connected with 53 msec, the delay difference from the terminal apparatus 30A is 2 msec, the original difference of 35 msec (equivalent to two frames at 60 fps) is overcome, and the delay time difference can be made to be equal to or smaller than the target value, i.e., the delay times can be equalized. Accordingly, the players using the terminal apparatuses 30A and 30B are enabled to fairly fight each other.

On the other hand, even if the regenerated photonic path (Optimized_Path) is used, the delay time difference may be larger than the target value of the delay time difference in the service policy 120 and the target value may not be accomplished (Step S206, NO).

In this case, the photonic path management unit 102 of the service providing server 10 notifies the terminal apparatuses 30A and 30B that the delay time difference does not become equal to or smaller than the target value even when the regenerated photonic path (Optimized_Path) is used via the Internet N1 or the all-photonics network N2 (Step S210).

In a case where the delay time difference does not become equal to or smaller than the target value even when the regenerated photonic path (Optimized_Path) is used, if the service policy 120 has described buffer adjustment as an adjustment method used for accomplishing the target value of the delay time difference, the delay management unit 106 of the service providing server 10 performs processing for executing the buffer adjustment (Step S211). Specifically, the delay management unit 106 causes the service providing unit 105 or the terminal apparatuses 30 to delay sending or executing a command so that the delay time difference becomes equal to or smaller than the target value. When controlling the terminal apparatuses 30, the delay management unit 106 causes at least the terminal apparatus 30B (terminal apparatus connected through a photonic path other than a photonic path which has a maximum delay time) to delay sending and/or executing the command.

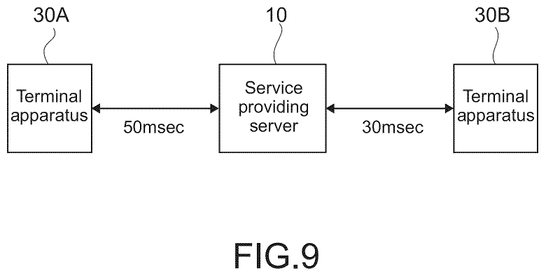

FIG. 9 is a diagram for describing an operation of the delay management unit.

As an example, it is assumed that the delay time of the photonic path to the terminal apparatus 30A from the service providing server 10 is 50 msec and the delay time of the photonic path to the terminal apparatus 30B from the service providing server 10 is 30 msec.

As an example, the delay times to the terminal apparatuses 30A and 30B from the service providing server 10 are made to equal 100 msec as a target. The delay management unit 106 causes the terminal apparatus 30A to delay sending and executing a command constantly +50 msec (=100−50). The delay management unit 106 causes the terminal apparatus 30B to delay sending and executing a command constantly +70 msec (=100−30). As a result, a total value (100 msec) of the delay time (50 msec) associated with the communication of the terminal apparatus 30A and a voluntarily increased delay time (50 msec) equals a total value (100 msec) of the delay time (30 msec) associated with the communication of the terminal apparatus 30B and a voluntarily increased delay time (70 msec).

As a modified example, the delay times to the terminal apparatuses 30A and 30B from the service providing server 10 are made to equal 50 msec as a target. The delay management unit 106 causes the terminal apparatus 30B to delay sending and executing a command constantly 20 msec (=50−30). As a result, the delay time (50 msec) associated with the communication of the terminal apparatus 30A equals a total value (50 msec) of the delay time (30 msec) associated with the communication of the terminal apparatus 30B and a voluntarily increased delay time (20 msec).

As a modified example, the delay times to the terminal apparatuses 30A and 30B from the service providing server 10 is made to equal 50 msec as a target. The delay management unit 106 causes the service providing unit 105 to delay sending a command to the terminal apparatus 30B constantly +20 msec (=50−30). As a result, the delay time (50 msec) associated with the communication of the terminal apparatus 30A equals a total value (50 msec) of the delay time (30 msec) associated with the communication of the terminal apparatus 30B and a voluntarily increased delay time (20 msec).

In this manner, the delay management unit 106 of the service providing server 10 may cause a local device of the terminal apparatuses 30 to execute processing for executing the buffer adjustment or the service providing unit 105 of the service providing server 10 to execute processing for executing the buffer adjustment.

### II. Second Embodiment

Hereinafter, the configuration and operation similar to the configuration and operation of the embodiment already described will be denoted by similar reference signs and the descriptions will be omitted and different points will be mainly described.

In the first embodiment, the photonic path determining unit 104 of the service providing server 10 inquires (Step S202) of the network management server 20 about the delay times of the respective photonic paths to the terminal apparatuses 30A and 30B connected (Step S103). In this regard, in a second embodiment, the photonic path determining unit 104 further causes the network management server 20 to generate another photonic path to at least one terminal apparatus 30 and inquires of a delay time of this photonic path.

The operation flow of the photonic path determining unit 104 according to the second embodiment may be executed instead of the operation flow of the photonic path determining unit 104 (FIG. 8) according to the first embodiment. Alternatively, the operation flow of the photonic path determining unit 104 (FIG. 8) according to the first embodiment may be first executed, the operation flow of the photonic path determining unit 104 according to the second embodiment may be executed in a case where the target value of the delay time difference has not been accomplished (Step S206, NO).

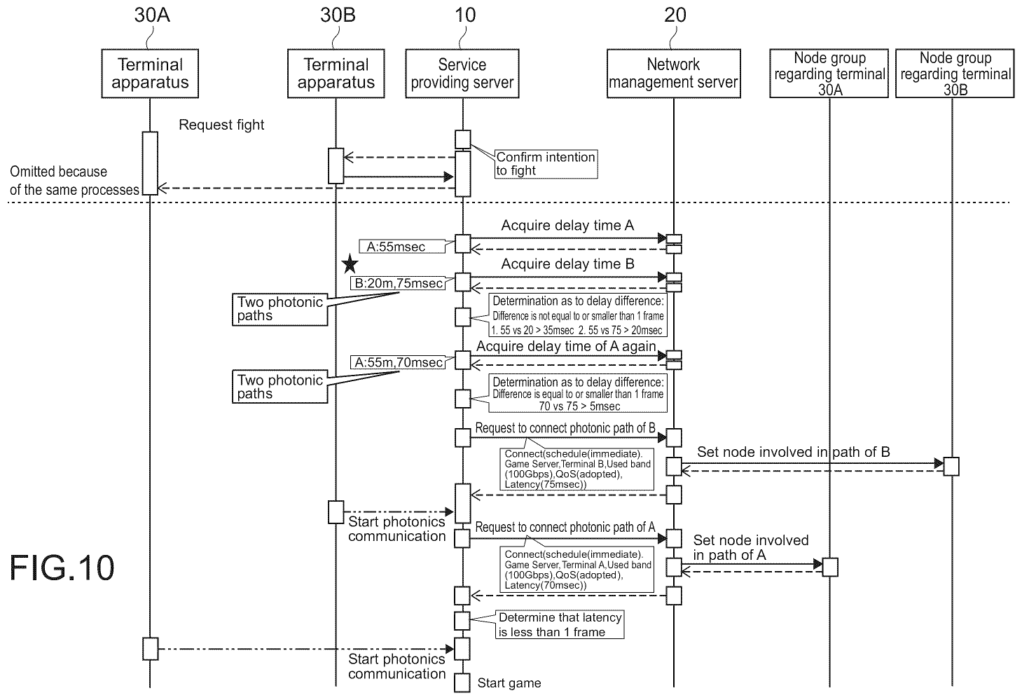

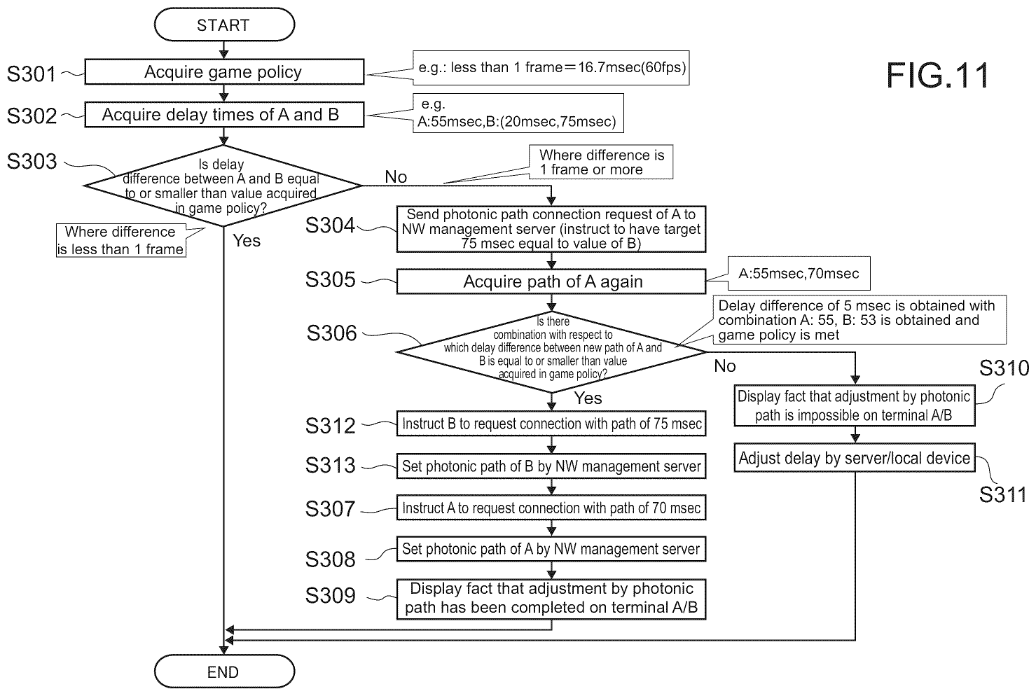

FIG. 10 shows an operation sequence of a service providing system according to the second embodiment. FIG. 11 shows an operation flow of the service providing server.

The photonic path determining unit 104 of the service providing server 10 refers to the service policy 120 and reads out a target value of the delay time difference (in this example, 16.7 msec), an adjustment method (photonic path adjustment and buffer adjustment) used for accomplishing the target value of the delay time difference, and a target value of power consumption for example (Step S301).

The photonic path determining unit 104 of the service providing server 10 inquires of the network management server 20 about delay times of the respective photonic paths to the terminal apparatuses 30A and 30B to which the network management server 20 has been connected (Step S103) and further causes to regenerate a photonic path for each photonic path to one terminal apparatus 30 and inquires about a delay time of this photonic path (Step S302). For example, the photonic path determining unit 104 regenerates a photonic path for each photonic path to the terminal apparatus 30B of the connected terminal apparatuses 30A and 30B, which has a shorter delay time, and inquires about a delay time of this photonic path.

The photonic path generating unit 201 of the network management server 20 receives the inquiry from the service providing server 10. Then, the photonic path generating unit 201 refers to the resource management database 220 and calculates delay times of the respective photonic paths to the terminal apparatuses 30A and 30B from the service providing server 10. The photonic path generating unit 201 regenerates a photonic path to one terminal apparatus 30B from the service providing server 10 and calculates a delay time of the regenerated photonic path. The photonic path generating unit 201 sends to the service providing server 10 the delay times of the respective photonic paths to the terminal apparatuses 30A and 30B from the service providing server 10.

The photonic path determining unit 104 of the service providing server 10 receives from the network management server 20 the delay times of the respective photonic paths to the terminal apparatuses 30A and 30B. In this example, the delay time of the photonic path to the terminal apparatus 30A from the service providing server 10 is 55 msec and the delay times of the photonic paths to the terminal apparatus 30B from the service providing server 10 are 20 msec and 75 msec.

The photonic path determining unit 104 determines (Step S303) whether or not a delay time difference, which is a difference between the delay time (55 msec) of the photonic path to the terminal apparatus 30A from the service providing server 10 and the delay times (20 msec, 75 msec) of the photonic paths to the terminal apparatus 30B from the service providing server 10, is equal to or smaller than the target value (16.7 msec) of the delay time difference in the service policy 120 (Step S301).

In this example, the photonic path determining unit 104 determines that one delay time difference (55−20=35 msec, 75−55=20 msec) is larger than the target value (16.7 msec) and the target value is not accomplished (Step S303, NO).

The photonic path determining unit 104 compares the delay time (55 msec) of the photonic path to the terminal apparatus 30A with the delay times (20 msec, 75 msec) of the photonic paths to the terminal apparatus 30B and determines a photonic path which has a maximum delay time and another photonic path. In this example, the photonic path determining unit 104 determines that the photonic path to the terminal apparatus 30B becomes the maximum delay time (75 msec) and the photonic path to the terminal apparatus 30A has a delay time (55 msec) other than the maximum delay time.

The photonic path management unit 102 of the service providing server 10 sends to the network management server 20 a photonic path regeneration request for requesting to regenerate a photonic path which does not have the maximum delay time, i.e., the photonic path to the terminal apparatus 30A. The photonic path regeneration request includes a schedule (in this example, immediate), a connection hub (terminal apparatus 30A, service providing server 10), a used band (e.g., 100 Gbps), QoS (in this example, adopted), and a target delay time (75 msec). The “target delay time” is the maximum delay time, i.e., the delay time (75 msec) of the photonic path to the terminal apparatus 30B. In other words, the photonic path management unit 102 requests the network management server 20 to regenerate a photonic path to the terminal apparatus 30A, which is a photonic path other than the photonic path to the terminal apparatus 30B with the maximum delay time (75 msec), so that the delay time difference from the maximum delay time (75 msec) becomes equal to or smaller than the target value (16.7 msec) (Step S304).

The photonic path generating unit 201 of the network management server 20 receives the photonic path regeneration request from the service providing server 10. The photonic path generating unit 201 refers to the resource management database 220 and regenerates a photonic path to the terminal apparatus 30A from the service providing server 10. For example, the photonic path generating unit 201 refers to the distance 224 and the latency 225 of the resource management database 220 and regenerates a photonic path (so-called detouring photonic path) with respect to which the delay time to the terminal apparatus 30A from the service providing server 10 is the closest to 75msec, as Optimized_Path. The photonic path generating unit 201 sends to the service providing server 10 information for performing communication in the regenerated photonic path (Optimized_Path) to the terminal apparatus 30A and a delay time of this photonic path.

The photonic path management unit 102 of the service providing server 10 receives from the network management server 20 the information for performing communication in the regenerated photonic path (Optimized_Path) to the terminal apparatus 30A and the delay time of this photonic path (Step S305). In this example, the delay time of the regenerated photonic path (Optimized_Path) is 70 msec.

The photonic path determining unit 104 of the service providing server 10 determines (Step S306) whether or not a delay time difference, which is a difference between the delay time of the photonic path to the terminal apparatus 30B (75msec) and the delay time (70 msec) of the regenerated photonic path (Optimized_Path) to the terminal apparatus 30A, is equal to or smaller than the target value (16.7 msec) of the delay time difference in the service policy 120 (Step S301). In this example, the photonic path determining unit 104 determines that the delay time difference (75−70=5 msec) is equal to or smaller than the target value (16.7 msec) and the target value has been accomplished (Step S306, YES). Thus, the photonic path determining unit 104 determines to use the respective photonic paths (with the delay times of 75 msec and 70 msec) with respect to which the delay time difference (2 msec) becomes equal to or smaller than the target value (16.7 msec).

The photonic path management unit 102 of the service providing server 10 sends information for performing communication in the photonic path to the terminal apparatus 30B from the service providing server 10, which has been regenerated (Step S302), and a delay time of this photonic path (75 msec) to the terminal apparatus 30B via the Internet N1 or the all-photonics network N2. Accordingly, communication via the photonic paths of the all-photonics network N2 (with the delay time of 75 msec) can be started between the service providing server 10 and the terminal apparatus 30B (Step S312).

The photonic path management unit 102 of the service providing server 10 sends to the network management server 20 a photonic path connection establishment request for connecting the photonic path to the terminal apparatus 30B, which has been generated (Step S302) by the network management server 20. The photonic path connection establishment request includes a schedule (in this example, immediate), a connection hub (terminal apparatus 30A, service providing server 10), a used band (e. g., 100 Gbps), QoS (in this example, adopted), and the delay time (75 msec) (Step S313).

In addition, the photonic path management unit 102 of the service providing server 10 sends information for performing communication in the photonic path (Optimized_Path) to the terminal apparatus 30A, which has been regenerated (Step S304), and a delay time of this photonic path (70 msec) to the terminal apparatus 30A via the Internet N1 or the all-photonics network N2. Accordingly, communication via the photonic paths of the all-photonics network N2 (with the delay time of 70 msec) can be started between the service providing server 10 and the terminal apparatus 30A (Step S307).

The photonic path management unit 102 of the service providing server 10 sends to the network management server 20 a photonic path connection establishment request for connecting the photonic path (Optimized_Path) to the terminal apparatus 30A, which has been regenerated by the network management server 20. The photonic path connection establishment request includes a schedule (in this example, immediate), a connection hub (terminal apparatus 30A, service providing server 10), a used band (e.g., 100 Gbps), QoS (in this example, adopted), and the delay time (70 msec) (Step S308).

The photonic path connecting unit 202 of the network management server 20 receives the photonic path connection establishment request from the service providing server 10. The photonic path connecting unit 202 establishes connection of the photonic paths to the terminal apparatuses 30A and 30B determined by the photonic path connection establishment request. The photonic path connecting unit 202 sends to the service providing server 10 a notification indicating that the connection of the photonic paths to the terminal apparatuses 30A and 30B has been established.

When the photonic path management unit 102 of the service providing server 10 receives the notification from the network management server 20, the photonic path management unit 102 of the service providing server 10 notifies the terminal apparatuses 30A and 30B that communication is enabled using the photonic path with respect to which the delay time difference (5 msec) becomes equal to or smaller than the target value (16.7 msec) via the Internet N1 or the all-photonics network N2 (Step S309).

The service providing unit 105 of the service providing server 10 uses the photonic paths with respect to which the delay time difference becomes equal to or smaller than the target value to perform communication with each of the terminal apparatuses 30A and 30B via the all-photonics network N2 and start to provide the service (game) (Step S106). As a result, the terminal apparatuses 30A and 30B are connected with 70 msec and 75 msec, the delay difference is 5 msec, the original difference of 20 msec is overcome, and the delay time difference can be made to be equal to or smaller than the target value, i.e., the delay times can be equalized. Accordingly, the players using the terminal apparatuses 30A and 30B are enabled to fairly fight each other.

The operation in a case where the target value of the delay time difference is not accomplished (Step S306, NO) is similar to Step S210 and Step S211 in the first embodiment (Step S310 and Step S311).

### III. Modified Examples

The photonic path determining unit 104 of the service providing server 10 may determine to use the photonic path with low power consumption. For example, in a case where the service policy 120 includes a target value of power consumption, the photonic path generation and connection request sent (Step S102) by the photonic path management unit 102 of the service providing server 10 to the network management server 20 may include the target value of power consumption. Accordingly, the photonic path determining unit 104 can determine to use a photonic path with low power consumption. The power consumption of the photonic path is calculated on the basis of power consumption 226 of each of the plurality of ports included in the photonic path, which has been stored in the resource management database 220.

In a case where the photonic path determining unit 104 determines that there is a plurality of sets each including the respective photonic paths with respect to which the delay time difference becomes equal to or smaller than the target value, the photonic path determining unit 104 may determine to use a set of photonic paths with lower total power consumption. For example, the plurality of photonic paths to the terminal apparatus 30A and the plurality of photonic paths to the terminal apparatus 30B are acquired (Step S304) and in a case where (Step S306, YES) there is a plurality of sets each including the respective photonic paths with respect to which the delay time difference becomes equal to or smaller than the target value, the photonic path determining unit 104 may determine to use a set of photonic paths to the terminal apparatuses 30A and 30B whose total power consumption, which is the sum of the power consumption of the photonic path to the terminal apparatus 30A and the power consumption of the photonic path to the terminal apparatus 30B, is the lowest. Alternatively, the photonic path determining unit 104 may determine to use a set of photonic paths with a shorter delay time (shortest path) irrespective of the total power consumption.

As shown in FIG. 3, by moving the instance of the service providing server 10, photonic paths with respect to which the delay time difference becomes equal to or smaller than the target value may be generated. For example, the photonic path generation and connection request sent (Step S102) by the photonic path management unit 102 of the service providing server 10 to the network management server 20 may include a parameter that allows movement of the instance of the service providing server 10. Accordingly, the delay times to the terminal apparatuses 30A and 30B of the photonic path can be closer values, and therefore it is possible to reduce the delay time difference.

### IV. Conclusion

In communication via the existing Internet network, it is difficult to equalize delay times of a plurality of players. Therefore, currently, a plurality of players assembles in the same site for an E-sports championship and the E-sports championship takes place via an Ethernet hub. Conversely, it is difficult to eliminate influences of the Internet network for realizing a remote E-sports championship with fair delays from remote locations.

In this regard, in the present embodiment, the all-photonics network characterized in that a communication channel (photonic path) between hubs is determined in advance and communication between the hubs occupies a single communication channel, such that the communication between the hubs is ensured irrespective of information included in electrical signals, is used. In the present embodiment, focusing on characteristics that “the delay time associated with the communication between the hubs is the fixed value” in the all-photonics network, a delay time difference between a delay time to the terminal apparatus 30A from the service providing server 10 and a delay time to the terminal apparatus 30B from the service providing server 10 is equal to or smaller than a target value, i.e., the delay times are equalized. Accordingly, the users of the plurality of terminal apparatuses 30A and 30B can experience the common service together fairly from remote locations (e.g., they perform a fight-type game under fair conditions). Therefore, it is possible to realize a remote E-sports championship with fair delays from remote locations.

The present disclosure can include the following configurations.
(1) A service providing server, including:
an all-photonics network communication interface for connecting to an all-photonics network;
a photonic path management unit that requests a network management server to generate and connect respective photonic paths to a plurality of terminal apparatuses connectable to the all-photonics network;
a photonic path determining unit that determines to use the respective photonic paths with respect to which a delay time difference becomes equal to or smaller than a target value, the delay time difference being a difference between delay times of the respective photonic paths generated by the network management server; and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server.
(2) The service providing server according to (1), in which
in a case where the photonic path determining unit determines that the delay time difference between the respective photonic paths is larger than the target value, the photonic path management unit requests the network management server to regenerate one photonic path so that the delay time difference becomes equal to or smaller than the target value.
(3) The service providing server according to (2), in which
the photonic path management unit requests the network management server to regenerate photonic paths other than a photonic path which has a maximum delay time so that a delay time difference with respect to the maximum delay time becomes equal to or smaller than the target value.
(4) The service providing server according to any one of (1) to (3), in which
the photonic path management unit
   requests the network management server to generate a plurality of photonic paths to one terminal apparatus, and
   requests, in a case where the photonic path determining unit determines that a delay time difference between each of the plurality of photonic paths to the one terminal apparatus and a photonic path to another terminal apparatus is larger than the target value, the network management server to regenerate photonic paths other than a photonic path which has a maximum delay time so that a delay time difference with respect to the maximum delay time becomes equal to or smaller than the target value.
(5) The service providing server according to (2) or (3), further including
a delay management unit that causes, in a case where the photonic path determining unit determines that the delay time difference between the respective photonic paths is larger than the target value after regeneration of the respective photonic paths, the service providing unit or a terminal apparatus connected through at least photonic paths other than a photonic path which has a maximum delay time to delay sending and/or executing a command so that the delay time difference becomes equal to or smaller than the target value.
(6) The service providing server according to any one of (1) to (5), in which
the photonic path management unit notifies the plurality of terminal apparatuses
   of the delay times of the respective photonic paths, and/or
   that the delay time difference becomes equal to or smaller than the target value.
(7) The service providing server according to any one of (1) to (6), in which
the photonic path determining unit determines to use a photonic path with low power consumption.
(8) The service providing server according to (4), in which
the photonic path determining unit determines to use a set of photonic paths with lower total power consumption in a case where the photonic path determining unit determines that there is a plurality of sets of the respective photonic paths with respect to which the delay time difference becomes equal to or smaller than the target value.
(9) The service providing server according to (7) or (8), in which
the power consumption of the photonic path is calculated on the basis of power consumption of each of a plurality of ports included in the photonic path.
(10) The service providing server according to any one of (1) to (9), in which
the photonic paths with respect to which the delay time difference becomes equal to or smaller than the target value are generated by moving an instance of the service providing server.
(11) The service providing server according to any one of (1) to (10), in which
the delay time of the photonic path is calculated on the basis of a communication time depending on a distance of the photonic path and latency of each of a plurality of ports included in the photonic path.
(12) A service providing method, including:
requesting a network management server to generate and connect respective photonic paths to a plurality of terminal apparatuses connectable to an all-photonics network;
determining to use the respective photonic paths with respect to which a delay time difference becomes equal to or smaller than a target value, the delay time difference being a difference between delay times of the respective photonic paths generated by the network management server; and
providing a common service that users of the plurality of terminal apparatuses experience together to the plurality of terminal apparatuses via the respective photonic paths with respect to which the delay time difference becomes equal to or smaller than the target value, the respective photonic paths being connected by the network management server.
(13) A service providing system, including:
a service providing server including
an all-photonics network communication interface for connecting to an all-photonics network,
a photonic path management unit that requests a network management server to generate and connect respective photonic paths to a plurality of terminal apparatuses connectable to the all-photonics network,
a photonic path determining unit that determines to use the respective photonic paths with respect to which a delay time difference becomes equal to or smaller than a target value, the delay time difference being a difference between delay times of the respective photonic paths generated by the network management server, and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server; and
the network management server that generates and connects the respective photonic paths to the plurality of terminal apparatuses from the service providing server.
(14) The service providing system according to (13), further including
the terminal apparatus including an all-photonics network communication interface for connecting to the all-photonics network.
(15) An information processing program that causes to a control circuit of a service providing server including an all-photonics network communication interface for connecting to an all-photonics network to operate as:
a photonic path management unit that requests a network management server to generate and connect respective photonic paths to a plurality of terminal apparatuses connectable to the all-photonics network;
a photonic path determining unit that determines to use the respective photonic paths with respect to which a delay time difference becomes equal to or smaller than a target value, the delay time difference being a difference between delay times of the respective photonic paths generated by the network management server; and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server.
(16) A non-transitory computer-readable recording medium recording an information processing program that causes to a control circuit of a service providing server including an all-photonics network communication interface for connecting to an all-photonics network to operate as:
a photonic path management unit that requests a network management server to generate and connect respective photonic paths to a plurality of terminal apparatuses connectable to the all-photonics network;
a photonic path determining unit that determines to use the respective photonic paths with respect to which a delay time difference becomes equal to or smaller than a target value, the delay time difference being a difference between delay times of the respective photonic paths generated by the network management server; and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server.

Although the embodiments and modified examples of the present technology have been described, the present technology is not limited only to the above-mentioned embodiments and can be variously modified without departing from the gist of the present technology as a matter of course.

### REFERENCE SIGNS LIST

1 service providing system
10 service providing server
100 control circuit
101 log-in unit
102 photonic path management unit
103 fight management unit
104 photonic path determining unit
105 service providing unit
106 delay management unit
111 storage apparatus
112 Internet communication interface
113 photonics network communication interface
120 service policy
20 network management server
200 control circuit
201 photonic path generating unit
202 photonic path connecting unit
211 storage apparatus
212 Internet communication interface
220 resource management database
30 terminal apparatus
300 control circuit
30A terminal apparatus
30B terminal apparatus
312 Internet communication interface
313 photonics network communication interface
N1 Internet
N2 photonics network

1. A service providing server, comprising:
an all-photonics network communication interface for connecting to an all-photonics network;
a photonic path management unit that requests a network management server to generate and connect respective photonic paths to a plurality of terminal apparatuses connectable to the all-photonics network;
a photonic path determining unit that determines to use the respective photonic paths with respect to which a delay time difference becomes equal to or smaller than a target value, the delay time difference being a difference between delay times of the respective photonic paths generated by the network management server; and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server.

2. The service providing server according to claim 1, wherein
in a case where the photonic path determining unit determines that the delay time difference between the respective photonic paths is larger than the target value, the photonic path management unit requests the network management server to regenerate one photonic path so that the delay time difference becomes equal to or smaller than the target value.

3. The service providing server according to claim 2, wherein
the photonic path management unit requests the network management server to regenerate photonic paths other than a photonic path which has a maximum delay time so that a delay time difference with respect to the maximum delay time becomes equal to or smaller than the target value.

4. The service providing server according to claim 1, wherein
the photonic path management unit
requests the network management server to generate a plurality of photonic paths to one terminal apparatus, and
requests, in a case where the photonic path determining unit determines that a delay time difference between each of the plurality of photonic paths to the one terminal apparatus and a photonic path to another terminal apparatus is larger than the target value, the network management server to regenerate photonic paths other than a photonic path which has a maximum delay time so that a delay time difference with respect to the maximum delay time becomes equal to or smaller than the target value.

5. The service providing server according to claim 2, further comprising
a delay management unit that causes, in a case where the photonic path determining unit determines that the delay time difference between the respective photonic paths is larger than the target value after regeneration of the respective photonic paths, the service providing unit or a terminal apparatus connected through at least photonic paths other than a photonic path which has a maximum delay time to delay sending and/or executing a command so that the delay time difference becomes equal to or smaller than the target value.

6. The service providing server according to claim 1, wherein
the photonic path management unit notifies the plurality of terminal apparatuses
of the delay times of the respective photonic paths, and/or
that the delay time difference becomes equal to or smaller than the target value.

7. The service providing server according to claim 1, wherein
the photonic path determining unit determines to use a photonic path with low power consumption.

8. The service providing server according to claim 4, wherein
the photonic path determining unit determines to use a set of photonic paths with lower total power consumption in a case where the photonic path determining unit determines that there is a plurality of sets of the respective photonic paths with respect to which the delay time difference becomes equal to or smaller than the target value.

9. The service providing server according to claim 7, wherein
the power consumption of the photonic path is calculated on a basis of power consumption of each of a plurality of ports included in the photonic path.

10. The service providing server according to claim 1, wherein
the photonic paths with respect to which the delay time difference becomes equal to or smaller than the target value are generated by moving an instance of the service providing server.

11. The service providing server according to claim 1, wherein
the delay time of the photonic path is calculated on a basis of a communication time depending on a distance of the photonic path and latency of each of a plurality of ports included in the photonic path.

12. A service providing method, comprising:
requesting a network management server to generate and connect respective photonic paths to a plurality of terminal apparatuses connectable to an all-photonics network;
determining to use the respective photonic paths with respect to which a delay time difference becomes equal to or smaller than a target value, the delay time difference being a difference between delay times of the respective photonic paths generated by the network management server; and
providing a common service that users of the plurality of terminal apparatuses experience together to the plurality of terminal apparatuses via the respective photonic paths with respect to which the delay time difference becomes equal to or smaller than the target value, the respective photonic paths being connected by the network management server.

13. A service providing system, comprising:
a service providing server including
an all-photonics network communication interface for connecting to an all-photonics network,
a photonic path management unit that requests a network management server to generate and connect respective photonic paths to a plurality of terminal apparatuses connectable to the all-photonics network,
a photonic path determining unit that determines to use the respective photonic paths with respect to which a delay time difference becomes equal to or smaller than a target value, the delay time difference being a difference between delay times of the respective photonic paths generated by the network management server, and
a service providing unit that provides a common service that users of the plurality of terminal apparatuses experience together to the plurality of terminal apparatuses via the respective photonic paths with respect to which the delay time difference becomes equal to or smaller than the target value, the respective photonic paths being connected by the network management server; and
the network management server that generates and connects the respective photonic paths to the plurality of terminal apparatuses from the service providing server.

14. The service providing system according to claim 13, further comprising
the terminal apparatus including an all-photonics network communication interface for connecting to the all-photonics network.
